(19) United States
(12) Patent Application Publication
(10) Pub. No.: US 2026/0005724 A1
(43) Pub. Date: Jan. 1, 2026

(54) COMMUNICATION DEVICE, SENDING DEVICE AND RECEIVING DEVICE

(71) Applicants: Premo, Inc., Tokyo (JP); The University of Tokyo, Tokyo (JP)

(72) Inventors: Shutai OKAMURA, Kanagawa (JP); Hidenori TSUJI, Tokyo (JP); Kenta HIGUCHI, Tokyo (JP); Junichiro KADOMOTO, Tokyo (JP); Hidetsugu IRIE, Tokyo (JP); Shuichi SAKAI, Tokyo (JP)

(21) Appl. No.: 18/948,547

(22) Filed: Nov. 15, 2024

(30) Foreign Application Priority Data
Jun. 26, 2024 (JP) 2024-102689

(51) Int. Cl. H04B 5/26; H01Q 7/00

(52) U.S. Cl. CPC H04B 5/26; H01Q 7/00

(57) ABSTRACT

There is provided a communication device including a sending unit which includes a first coil and a receiving unit which includes a second coil, wherein a resonance phenomenon of a magnetic field is generated in at least one of the first coil or the second coil, which causes the sending unit to send a signal to the receiving unit, and the signal is a signal at a secondary or higher resonant frequency. There may be provided a sending device including a sending unit which includes a coil, wherein a resonance phenomenon of a magnetic field at a secondary or higher resonant frequency in the coil causes a change in a magnetic field in a receiving unit, which causes communication from the sending unit to the receiving unit at the secondary or higher resonant frequency.

### BACKGROUND

### 1. Technical Field

The present invention relates to a communication device, a sending device, and a receiving device.

### 2. Related Art

Patent Document 1 describes “the horizontal inductive coupling is used to achieve a wireless connection between the chips.”

### PRIOR ART DOCUMENT

### Patent Document

Patent Document 1: International publication number WO2021/106777

### BRIEF DESCRIPTION OF THE DRAWINGS

FIG. 1 schematically illustrates a plan view of a communication device 10 according to the present embodiment.

FIG. 2 schematically illustrates functional blocks of a circuit unit 120 of a sending device 100.

FIG. 3 schematically illustrates functional blocks of a circuit unit 220 of a receiving device 200.

FIG. 4 schematically illustrates an equivalent circuit of resonance circuits 114 and 214 used in the communication device 10.

FIG. 5 illustrates an example of a relationship between an oscillation frequency and an impedance in the resonance circuits 114 and 214.

FIG. 6 illustrates an example of a relationship between a distance and a voltage amplitude when the communication device 10 is used as a distance measurement device.

FIG. 7 illustrates another example of a relationship between the distance and the voltage amplitude when the communication device 10 is used as the distance measurement device.

FIG. 8 illustrates another example which shows a positional relationship between a first coil and a circuit unit in a sending device.

FIG. 9 illustrates still another example which shows the positional relationship between the first coil and the circuit unit in the sending device.

FIG. 10 illustrates still another example which shows the positional relationship between the first coil and the circuit unit in the sending device.

FIG. 11 illustrates still another example which shows the positional relationship between the first coil and the circuit unit in the sending device.

### DESCRIPTION OF EXEMPLARY EMBODIMENTS

Though the present invention will be hereinafter described through embodiments of the present invention, the following embodiments are not intended to limit the invention according to the claims. In addition, not all combinations of features described in the embodiments are essential to a solution of the invention.

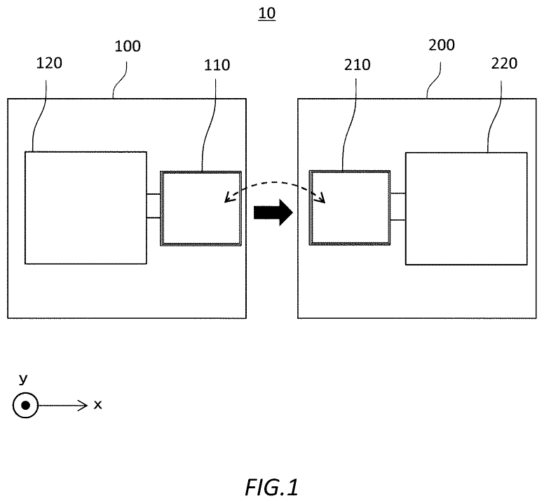

FIG. 1 schematically illustrates a plan view of a communication device 10 according to the present embodiment. The communication device 10 includes a sending device 100 and a receiving device 200, and sends a signal from the sending device 100 to the receiving device 200 in a wireless manner using magnetic field resonance which is sometimes referred to as magnetic resonance coupling, resonant magnetic coupling, resonant coupling, or resonance coupling. The magnetic field resonance will be described later. For convenience of description, a left-to-right direction in FIG. 1 is defined as an x direction, and a direction perpendicular to a paper plane is defined as a y direction, and these directions will be used also in other figures as appropriate.

The sending device 100 includes a first coil 110 and a circuit unit 120 electrically connected to the first coil 110. In an example of FIG. 1, the sending device 100 is formed as a single chip. That is, the first coil 110 and the circuit unit 120 are formed within the single chip. Furthermore, in the example of FIG. 1, the first coil 110 is wound on a main surface of the chip, namely a largest surface of the chip. The circuit unit 120 is arranged outside the first coil 110.

The receiving device 200 includes a second coil 210 and a circuit unit 220 electrically connected to the second coil 210. The receiving device 200 is also formed as a single chip, and a spatial arrangement relationship between the second coil 210 and the circuit unit 220 is symmetric with the arrangement relationship between the first coil 110 and the circuit unit 120 of the sending device 100.

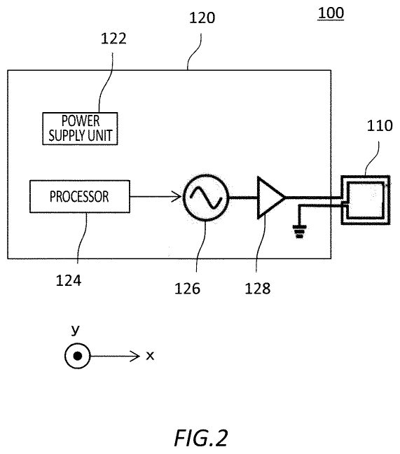

FIG. 2 schematically illustrates functional blocks of the circuit unit 120 of the sending device 100. The circuit unit 120 includes a power supply unit 122, a processor 124, an oscillator 126, and an operational amplifier 128.

The power supply unit 122 supplies electrical power to the processor 124, the oscillator 126, and the operational amplifier 128. Wiring for supplying the electrical power is not illustrated for simplicity.

The processor 124 sends a signal for controlling ON/OFF of the oscillator 126, based on an external instruction such as from a user, or at a predetermined timing. The oscillator 126 oscillates to generate an electrical signal of a sine wave at a predetermined frequency based on an ON signal from the processor 124 and sends it to the operational amplifier 128. The operational amplifier 128 adjusts intensity or the like of the received electrical signal and sends it to the first coil 110. In this way, an alternating magnetic field at a predetermined frequency is generated in the first coil 110.

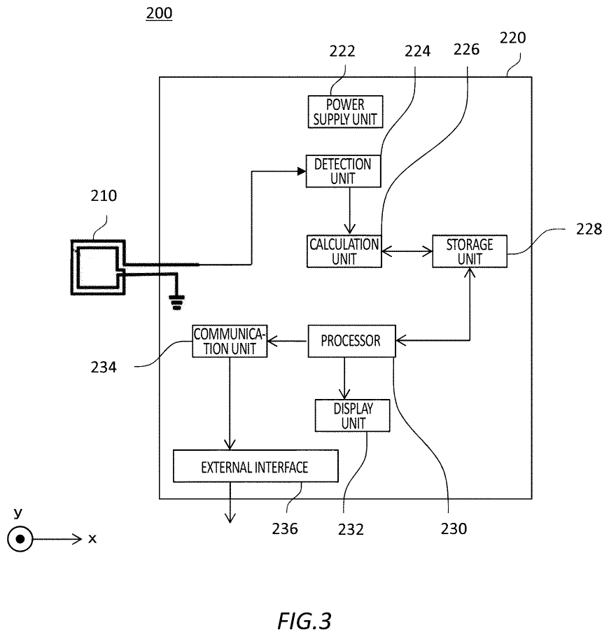

FIG. 3 schematically illustrates functional blocks of the circuit unit 220 of the receiving device 200. The circuit unit 220 includes a power supply unit 222, a detection unit 224, a calculation unit 226, a storage unit 228, a processor 230, a display unit 232, a communication unit 234, and an external interface 236.

The power supply unit 222 supplies electrical power to the detection unit 224, the calculation unit 226, the storage unit 228, the processor 230, the display unit 232, the communication unit 234, and the external interface 236. Wiring for supplying the electrical power is not illustrated for simplicity.

The detection unit 224 detects an amplitude of an induced voltage generated by induction in the second coil 210. Based on the amplitude detected in the detection unit 224, the calculation unit 226 refers to the storage unit 228 and calculates a positional relationship between the first coil 110 and the second coil 210.

The storage unit 228 has stored amplitudes of the induced voltage and positional relationships in advance. The storage unit 228 further stores a calculation result from the calculation unit 226.

The processor 230 sends the calculation result stored in the storage unit 228 to the display unit 232 and/or the communication unit 234 based on an external instruction such as from the user, or at a predetermined timing.

The display unit 232 is, for example, a liquid crystal display or a 7-segment display, and displays the calculation result so as to be visible to the user. The communication unit 234 outputs a detection result externally via the external interface 236 in a wired or wireless manner. The external interface 236 may be a serial communication connector, an ETHERNET (registered trademark) connector, or the like in the wired manner, or may be an antenna or the like in the wireless manner.

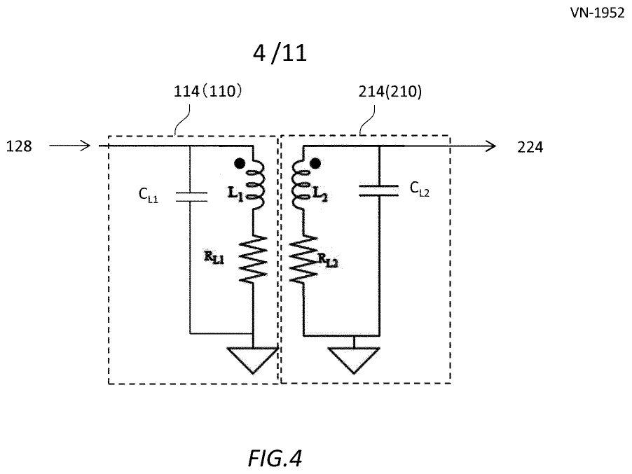

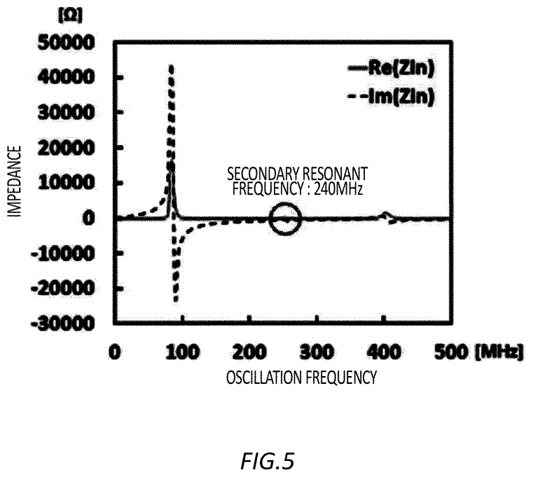

FIG. 4 schematically illustrates an equivalent circuit of resonance circuits 114 and 214 used in the communication device 10. FIG. 5 illustrates an example of a relationship between an oscillation frequency and an impedance in the resonance circuits 114 and 214.

As described above, the communication device 10 uses the magnetic field resonance. Though the magnetic field resonance is sometimes referred to as magnetic field resonation, magnetic resonance, magnetic resonation, or the like, the term “magnetic field resonance” will be used for description throughout the specification. The magnetic field resonance is different from magnetic field coupling, in which a signal and energy are transmitted simply via magnetic coupling between a sending coil and a receiving coil, in the following.

In the magnetic field resonance, a resonance circuit including a coil is provided in at least one of a sending side or a receiving side, and the signal and energy are transmitted using a resonance phenomenon of a magnetic field in the resonance circuit. In this case, transmission efficiency for sending and receiving has a positive correlation with a product kQ of a coupling coefficient k and a Q value of a resonator. The Q value of the resonator assumes an extreme value at a resonant frequency.

In the present embodiment, the resonance circuit 114 is provided in the sending device 100 and the resonance circuit 214 is provided in the receiving device 200. Furthermore, each of the resonance circuits 114 and 214 is resonated at a same resonant frequency.

The resonance circuit 114 of the sending device 100 illustrated in FIG. 4 consists of an inductance L1 of the first coil 110 itself, a parasitic capacitance C_{L1}, and a parasitic resistance R_{L1}, and resonates at a resonant frequency determined by them. That is, a capacitor element and a resistance element separate from the first coil 110, which contribute to the resonance circuit 114, are not provided. In addition, the resonance circuit 114 resonates at a self-resonant frequency.

FIG. 5 illustrates an example of a relationship between an oscillation frequency and an impedance for a coil, which is provided on a PCB substrate and of 1 cm square, has a thickness and spacing of 0.08 mm, and has 20 turns. In the example of FIG. 5, it can be seen that resonance occurs at a primary resonant frequency of around 95 MHZ, a secondary resonant frequency of around 240 MHz, and a tertiary resonant frequency of around 400 MHZ. Note that, as illustrated in FIG. 5, the resonant frequency is a frequency at which an imaginary part, or a reactance, of the impedance becomes zero. That is, the primary resonant frequency means a lowest frequency among frequencies at which a reactance component of the resonance circuit 114 becomes zero.

In the present embodiment, among these resonant frequencies, a secondary or higher resonant frequency, for example, the secondary resonant frequency is used. Here, the secondary resonant frequency means a second lowest frequency among frequencies at which the reactance component of the resonance circuit 114 becomes zero. The oscillator 126 in FIG. 3 is designed to oscillate to generate the sine wave at a resonant frequency to be used. For example, in the present embodiment, the oscillator 126 oscillates to generate the sine wave at the secondary resonant frequency of 240 MHz.

Similar to the resonance circuit 114, the resonance circuit 214 of the receiving device 200 illustrated in FIG. 4 also consists of an inductance L2 of the second coil 210 itself, a parasitic capacitance C_{L2}, and a parasitic resistance R_{L2}, and resonates at a self-resonant frequency. The resonant frequency of the resonance circuit 214, such as the secondary resonant frequency, is preferably designed to be the same as the corresponding resonant frequency of the resonance circuit 114.

Due to resonance of the resonance circuits 114 and 214, the induced voltage is generated in the second coil 210 in response to a periodic change in the magnetic field. The detection unit 224 in FIG. 3 detects the amplitude using a temporal average or a peak value of the induced voltage.

In the present embodiment, the transmission efficiency can be improved by using the magnetic field resonance. For example, when the magnetic field coupling is used, communication is possible only over a distance of up to about 1/10 times a side of a coil or a diameter of the coil in a case where the coil has a circular shape, whereas when the magnetic field resonance is used, the communication is possible over a distance of up to about several times the side of the coil or the diameter of the coil in the case where the coil has a circular shape.

In the present embodiment, each of the resonance circuits 114 and 214 operates at a resonant frequency which takes into account the parasitic capacitance of the coil. Accordingly, it is possible to avoid a discrepancy between the resonant frequencies of the sending side and the receiving side due to unmatched LC characteristics thereof and perform a transmission with high efficiency without adjusting a capacitance value.

In the present embodiment, the secondary or higher resonant frequency is used in the resonance circuits 114 and 214. This increases a degree of freedom of a circuit design. In this case, a higher frequency is more preferable, since it allows a circuit scale to be smaller and may provide a higher resolution when used as a measurement device. In addition, it is possible to select and use a resonant frequency which makes an output voltage of the second coil 210 for reception in the receiving device 200 to be highest.

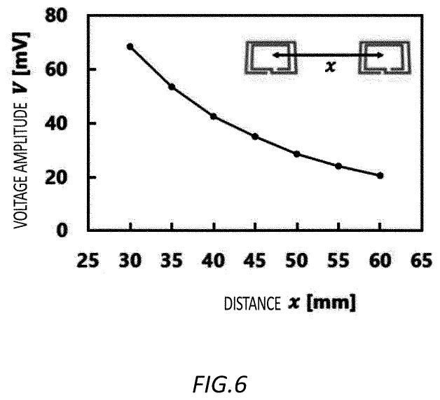

FIG. 6 illustrates an example of a relationship between a distance and a voltage amplitude when the communication device 10 is used as a distance measurement device. FIG. 6 illustrates an example in which coils described as the first coil 110 and the second coil 210 in FIG. 5 are used and the secondary resonant frequency of 240 MHz is used.

It is assumed that the sending device 100 and the receiving device 200 of the communication device 10 are arranged to be movable relative to each other in the x direction. In this case, as illustrated in FIG. 6, the voltage amplitude V (mV) detected in the detection unit 224 of the receiving device 200 has a negative correlation with a distance×(mm) between the sending device 100 and the receiving device 200.

Accordingly, if a relationship between the distance x and the voltage amplitude V has been calculated experimentally or by a computation in advance and stored in the storage unit 228, the calculation unit 226 can calculate the distance x by referring to the storage unit 228 based on the voltage amplitude V detected in the detection unit 224.

In this case, since the receiving device 200 includes the power supply unit 222 in itself, it does not need to be supplied with the electrical power for driving from the sending device 100. Accordingly, an absolute value of the voltage amplitude does not need to be large in order to use the communication device 10 as the distance measurement device which calculates distance x. In the example illustrated in FIG. 6, it can be seen that the communication device 10 can be used adequately as the distance measurement device over a distance of up to about 6 times the side of the coil.

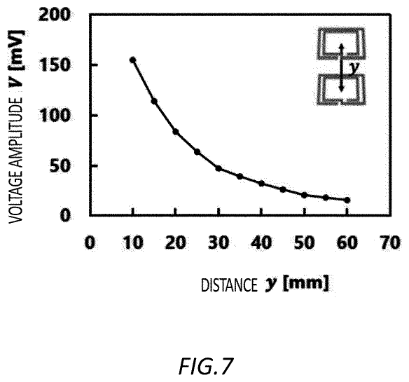

FIG. 7 illustrates another example of a relationship between the distance and a detected voltage when the communication device 10 is used as the distance measurement device. In FIG. 7, in contrast to FIG. 1, it is assumed that the sending device 100 and the receiving device 200 of the communication device 10 are aligned in the y direction and arranged to be movable in the y direction.

In this case again, as illustrated in FIG. 7, the voltage amplitude V (mV) detected in the detection unit 224 of the receiving device 200 has a negative correlation with a distance y (mm) between the sending device 100 and the receiving device 200. Accordingly, if a relationship between the distance y and the voltage amplitude V has been calculated experimentally or by the computation in advance and stored in the storage unit 228, the calculation unit 226 can calculate the distance y by referring to the storage unit 228 based on the voltage amplitude V detected in the detection unit 224.

FIG. 6 and FIG. 7 illustrate the examples in which the communication device 10 is used as the distance measurement device. Not being limited thereto, the communication device 10 can be also used as an angle measurement device. In this case, the sending device 100 and the receiving device 200 are arranged to be rotatable relative to each other on a xy-plane in FIG. 1, and a relationship between the angle and the voltage amplitude V has been calculated experimentally or by a computation in advance and stored in the storage unit 228. In this way, the calculation unit 226 can calculate the angle by referring the storage unit 228 based on the voltage amplitude V detected in the detection unit 224.

As described above, when the sending device 100 and the receiving device 200 are arranged to have a variable positional relationship with 1 degree of freedom, and the relationship between the positional relationship in the degree of freedom and the voltage amplitude is known, the communication device 10 can be used as a measurement device for measuring the positional relationship.

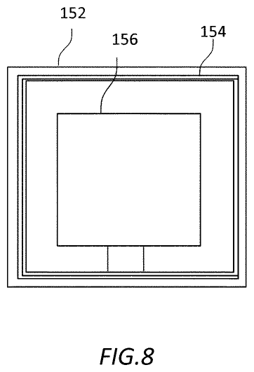

FIG. 8 illustrates another example which shows a positional relationship between a first coil and a circuit unit in a sending device. In a sending device 150 of FIG. 8, a first coil 154 and a circuit unit 156 are provided on a same chip 152. However, in contrast to FIG. 1, the first coil surrounds the circuit unit 156, and is wound around near an outer circumference of a main surface of the chip 152.

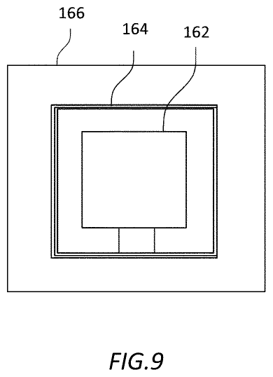

FIG. 9 illustrates another example which shows the positional relationship between the first coil and the circuit unit in the sending device. In a sending device 160 of FIG. 9, a first coil 164 and a chip 162 are arranged on a substrate 166 such as a PCB substrate. A circuit unit of the sending device 160 is provided in the chip 162. In the sending device 160, the first coil 164 is arranged on the substrate 166 to surround the chip 162.

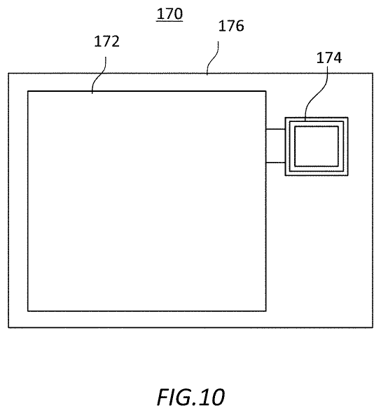

FIG. 10 illustrates still another example which shows the positional relationship between the first coil and the circuit unit in the sending device. In a sending device 170 of FIG. 10, a first coil 174 and a chip 172 are arranged on a substrate 176 such as the PCB substrate. A circuit unit of the sending device 170 is provided in the chip 172. In the sending device 170, the first coil 174 does not surround the chip 172, that is, the chip 172 is arranged outside the first coil 174.

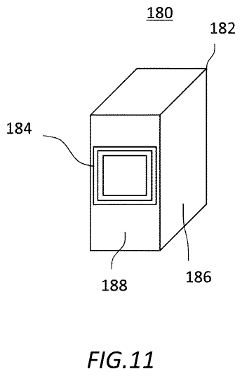

FIG. 11 illustrates still another example which shows the positional relationship between the first coil and the circuit unit in the sending device. In a sending device 180 of FIG. 11, a first coil 184 is arranged not on a main surface 186, but on a side surface 188 of a chip 182. In addition, the first coil 184 is wound on the side surface 188.

As described above, a sending circuit, the chip, and the first coil in the sending device can be arranged variously. Similarly, also in the receiving device, a receiving circuit, the chip, and the second coil can be arranged variously such as in FIG. 8 to FIG. 11. In addition, the arrangement in the sending device and the arrangement in the receiving device may be different.

According to the above-described embodiment, each of the sending device 100 and the receiving device 200 is provided with the resonance circuits 114 and 214 respectively, each of which causes the resonance. As an alternative to this, either one of the sending device 100 or the receiving device 200 may be provided with the resonance circuit, which causes the resonance.

The oscillator 126 of FIG. 2 oscillates to generate the sine wave at a frequency which corresponds to the secondary or higher resonant frequency. As an alternative to this, it may oscillate using another periodic oscillation, such as a triangular wave, a rectangular wave, or the like.

When the communication device 10 is not used as the measurement device in itself, the calculation unit 226 of FIG. 3 may not be provided. In this case, it may output a value of the amplitude detected in the detection unit 224 externally, and the positional relationship between the sending device 100 and the receiving device 200 may be calculated externally. In this case, the storage unit 228 may also not be provided.

Neither of the resonance circuits 114 and 214 of FIG. 4 is provided with the capacitor element and the resistance element separate from the first coil 110 and the second coil 210. As an alternative to this, the capacitor element and the resistance element separate from the first coil 110 and the second coil 210 may be provided.

While the present invention has been described by using the embodiments hereinabove, the technical scope of the present invention is not limited to the scope described in the above-described embodiments. It is apparent to persons skilled in the art that various changes or improvements may be made to the above-described embodiments. It is apparent from description of the claims that the embodiments to which such changes or improvements are made may also be included in the technical scope of the present invention.

It should be noted that each process such as the operations, procedures, steps, and stages in the device, system, program, and method shown in the claims, specification, and drawings may be executed in any order as long as the order is not particularly explicitly indicated by “prior to”, “before”, or the like and as long as the output from a previous process is not used in a later process. Even if the operational flow in the claims, specification, and drawings is described by using phrases such as “first”, “next”, or the like for the sake of convenience, it does not necessarily mean that it must be performed in this order.

### EXPLANATION OF REFERENCES

10: communication device; 166, 176: substrate; 100, 150, 160, 170, 180: sending device; 110, 154, 164, 174, 184: first coil; 114: resonance circuit; 120, 156: circuit unit; 122: power supply unit; 124: processor; 126: oscillator; 128: operational amplifier; 152, 162, 172, 182: chip; 186: main surface; 188: side surface; 200: receiving device; 210: second coil; 214: resonance circuit; 220: circuit unit; 222: power supply unit; 224: detection unit; 226: calculation unit; 228: storage unit; 230: processor; 232: display unit; 234: communication unit; 236: external interface.

What is claimed is:

1. A communication device comprising:
a sending unit which comprises a first coil; and
a receiving unit which comprises a second coil, wherein
a resonance phenomenon of a magnetic field is generated in at least one of the first coil or the second coil, which causes the sending unit to send a signal to the receiving unit, and
the signal is a signal at a secondary or higher resonant frequency.

2. The communication device according to claim 1, wherein the sending unit further comprises an oscillator which oscillates to generate a sine wave signal at the secondary or higher resonant frequency.

3. The communication device according to claim 1, wherein the at least one of the first coil or the second coil comprises a parasitic capacitance which constitutes a resonance circuit.

4. The communication device according to claim 3, wherein each of the first coil and the second coil comprises the parasitic capacitance which constitutes the resonance circuit.

5. The communication device according to claim 1, wherein the receiving unit further comprises:
a detection unit which detects an amplitude of an induced voltage in the second coil which depends on a change in the magnetic field, and
a calculation unit which calculates a positional relationship between the first coil and the second coil based on the amplitude detected in the detection unit.

6. The communication device according to claim 5, wherein
the receiving unit further comprises a storage unit which stores amplitudes of the induced voltage and positional relationships, and
the calculation unit calculates the positional relationship by referring to the storage unit.

7. A sending device comprising:
a sending unit which comprises a coil, wherein
a resonance phenomenon of a magnetic field at a secondary or higher resonant frequency in the coil causes a change in a magnetic field in a receiving unit, which causes communication from the sending unit to the receiving unit at the secondary or higher resonant frequency.

8. A receiving device comprising:
a receiving unit which comprises a coil, wherein
a resonance phenomenon of a magnetic field at a secondary or higher resonant frequency in the coil causes a change in the magnetic field in the receiving unit, which causes communication from a sending unit to the receiving unit at the secondary or higher resonant frequency.
